(19) United States
(12) Patent Application Publication
(10) Pub. No.: US 2026/0192759 A1
(43) Pub. Date: Jul. 9, 2026

(54) MOULDED PART

(71) Applicant: Novem Car Interior Design GmbH, Vorbach (DE)

(72) Inventor: Philipp WEIH, Haag (DE)

(21) Appl. No.: 18/881,896

(22) PCT Filed: Jul. 6, 2023
(86) PCT No.: PCT/EP2023/068712

§ 371 Date: Jan. 7, 2025

(30) Foreign Application Priority Data
Jul. 7, 2022 (DE) 10 2022 116 953.7

(51) Int. Cl. B60R 13/02

(52) U.S. Cl. CPC B60R 13/02; B60R 2013/0287

(57) ABSTRACT

A shaped part may include a decorative layer having a front side designed as a visible side and a rear side opposite the front side, and a carrier arranged on the rear side of the decorative layer.

One or more CMUT sensor and/or control elements are arranged on or in the shaped part, wherein the CMUT sensor and/or control element(s) are provided for detecting a touch of or an approach towards the front side of the decorative layer by the operator.

### DESCRIPTION

The invention relates to a shaped part, in particular a decorative part and/or panel part designed as a shaped part for a vehicle interior.

Numerous decorative and panel parts are installed in the vehicle interior, for example door panels, console panels, and instrument panels. The decorative and panel parts also include control buttons or the covers of control buttons.

Such shaped parts comprise a decorative layer having a front side designed as a visible side and a rear side opposite the front side, and a carrier arranged on the rear side of the decorative layer.

The integration of sensor and/or control elements is often desired for such shaped parts in order to allow so-called “touch” functions on the shaped part surface. To date, capacitive sensor and/or control elements have been used in particular for this purpose. A disadvantage of capacitive sensor and/or control elements, however, is the fact that they cannot be used behind conductive layers of the shaped parts, as the conductive layer impairs the sensor. For example, it is not possible to provide touch sensors or control elements behind conductive decorative surfaces such as aluminum or carbon.

The present invention is based on the object of specifying a new shaped part, in particular a new shaped part which at least largely avoids the aforementioned disadvantages and/or allows integration of touch sensors or control elements behind conductive surfaces.

This object is achieved by the features of claim 1. Advantageous embodiments and further developments are provided in the dependent claims.

The shaped part according to the invention comprises a decorative layer having a front side designed as a visible side and a rear side opposite the front side, and a carrier arranged on the rear side of the decorative layer. The shaped part according to the invention is characterized in that one or more CMUT sensor and/or control elements are arranged on or in the shaped part, wherein the CMUT sensor and/or control element(s) are provided for detecting a touch of or approach towards the front side of the decorative layer by an operator.

The shaped part according to the invention is in particular a decorative part and/or panel part designed as a shaped part for a vehicle interior.

The operating principle of sensor and/or control elements based on CMUT (Capacitive Micromachined Ultrasonic Transducers) technology is based on the transmission and detection of ultrasonic waves.

The advantages of the invention are therefore in particular that with the new CMUT sensors—in contrast to capacitive sensors—it is possible to detect a touch or approach by the hand or finger of an operator through conductive shaped part surfaces or layers of the shaped part, such as a decorative layer made of aluminum or carbon.

Touching or approaching by an operator is understood to mean not only touching or approaching by the operator himself, but also touching or approaching by objects used by an operator as an aid, such as pens, whose touching or approaching the front side of the decorative layer by a user is detected by the CMUT sensor and/or control elements.

According to a preferred embodiment of the invention, the decorative layer comprises a conductive material or is made of a conductive material. The conductive material is or comprises in particular aluminum and/or carbon and/or stainless steel. Alternatively, the decorative layer could also be made of a non-conductive material. However, the advantages of the invention are particularly evident when a conductive material is used.

The carrier is preferably a plastics carrier, for example made of polycarbonate (PC) or acrylonitrile butadiene styrene (ABS) or polycarbonate/acrylonitrile butadiene styrene (PC-ABS). The carrier is preferably transparent or translucent. Alternatively, the carrier could also be made of stainless steel. It can be provided that both the decorative layer and the carrier are made of a single stainless steel layer. The carrier can have the same layer thickness throughout. Alternatively, the carrier can be thinned out in portions, preferably in the region of the CMUT sensor and/or control elements.

According to a further development of the invention, the CMUT sensor and/or control elements are attached, in particular glued and/or clipped and/or welded and/or screwed, to the rear side of the carrier.

In particular, the CMUT sensor and/or control element(s) are attached to the rear side of the carrier without an air gap and/or without an intermediate layer. In particular, a defined attachment without an air gap or intermediate layer is important to ensure error-free detection. In the case of gluing, an adhesive system with consistent properties, such as hardness, etc., must be used for attachment.

Particularly preferably, one or more symbols are provided on the front side of the decorative layer, wherein one CMUT sensor and/or control element is assigned to each symbol and/or is arranged in the region of the symbol on the rear side of the carrier.

Such symbols are preferably one or more functional symbols or geometries or shapes or conformal lines which are displayed on the visible side of the decorative layer of the shaped part, i.e., which are visible as such in particular in plan view of the visible side of the decorative layer. Furthermore, the symbol can also be one or more letters, logotypes, characters or other design elements.

It can be provided that the symbol(s) are each formed by one or more apertures, in particular by a micro-perforation formed by the apertures, in the decorative layer, wherein the aperture(s) extend from the rear side of the decorative layer to the front side of the decorative layer through the decorative layer, and wherein a lighting system, for example comprising one or more LEDs, is arranged on the rear side of the decorative layer, in particular on or in the carrier, wherein light emanating from the lighting system is or can be guided through the aperture(s) to the front side of the decorative layer in order to display the symbol.

Furthermore, it can be provided that the symbol(s) are formed by a partial printed and/or color coating on the front side of the decorative layer.

It can also be provided that the symbol(s) are formed by depressions in the surface of the decorative layer and/or elevations from the surface of the decorative layer, which are formed by embossing, for example.

In addition, mixed forms are also possible, wherein the symbols are formed partly by means of apertures (with or without backlighting) and/or partly by means of color and/or printed layers and/or partly by means of depressions and/or elevations.

According to one embodiment of the invention, the shaped part comprises one or more feedback elements for generating a feedback signal, wherein the feedback element(s) are connected to the CMUT sensor and/or control element(s) in order to output a feedback signal for the operator upon detection by the CMUT sensor and/or control element(s) of a touch of or an approach towards the front side of the decorative layer by an operator.

It can be provided that the feedback elements are or comprise haptic feedback elements, for example vibration devices, for outputting a haptic feedback signal, and/or visual feedback elements, for example lighting devices, for outputting a visual feedback signal and/or acoustic feedback elements, for example loudspeakers, for outputting an acoustic feedback signal.

A further development of the invention provides that the shaped part has a control device, wherein the control device is connected to the CMUT sensor and/or control element(s), wherein a control signal for controlling external units is generated by the control device when an operator touches or approaches the front side of the decorative layer as detected by the CMUT sensor and/or control elements.

The control signal can, for example, control external units provided in the vehicle interior, such as electrical and/or electronic units, for example the backrest and/or armrest adjustment devices, the air conditioning, the ventilation, the lighting, the radio and/or the navigation system, etc.

The invention is explained in more detail below also with regard to further features and advantages on the basis of the description of embodiments and with reference to the accompanying schematic drawings. In the figures:

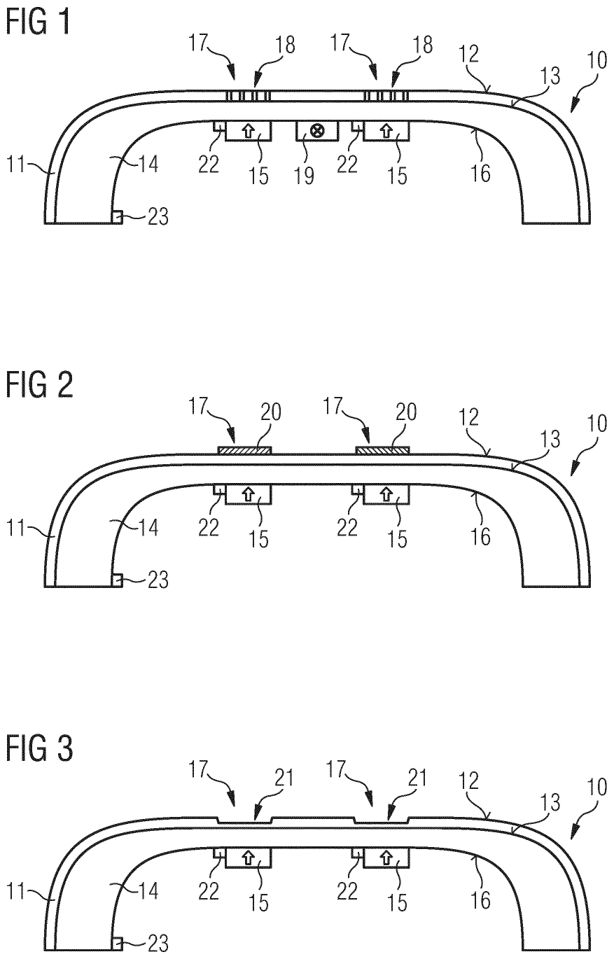

FIG. 1 shows a first embodiment of a shaped part according to the invention in a schematic sectional view;

FIG. 2 shows a second embodiment of a shaped part according to the invention in a schematic sectional view;

FIG. 3 shows a third embodiment of a shaped part according to the invention in a schematic sectional view.

Corresponding parts and components, also across the various embodiments, are identified by the same reference signs in FIGS. 1 to 3.

FIGS. 1 to 3 each show a decorative and/or panel part according to the invention, designed as a shaped part 10, for a vehicle interior. The shaped part 10 comprises a decorative layer 11 having a front side 12 designed as a visible side and a rear side 13 opposite the front side 12, and a carrier 14 arranged on the rear side 13 of the decorative layer 11.

Multiple CMUT sensor and/or control elements 15 are arranged on the shaped part 10 and are provided for detecting a touch of the front side 12 of the decorative layer 11 by an operator.

The decorative layer 11 is made of a conductive material, wherein the conductive material is preferably aluminum or carbon. The carrier 14 is preferably a transparent or translucent plastics carrier, preferably made of polycarbonate (PC) or polycarbonate/acrylonitrile butadiene styrene (PC-ABS).

The CMUT sensor and/or control elements 15 are attached, in particular glued, clipped or welded, to the rear side 16 of the carrier 14.

Multiple symbols 17 are provided on the front side 12 of the decorative layer 11, wherein one CMUT sensor and/or control element 15 is assigned to each symbol 17 and is arranged in the region of the symbol 17 on the rear side 16 of the carrier 14. The symbol 17, for example, is a functional symbol which is shown on the visible side of the decorative layer 11 of the shaped part 10. Furthermore, the symbols 17 can also be one or more letters, logotypes, characters or other design elements.

According to the embodiment shown in FIG. 1, each symbol 17 is formed by multiple apertures 18, in particular by a micro-perforation formed by the apertures 18, in the decorative layer 11. The apertures 18 extend from the rear side 13 of the decorative layer 11 to the front side 12 of the decorative layer 11 through the decorative layer 11. A lighting system 19 comprising one or more LEDs is arranged on the rear side 13 of the decorative layer 11, attached to the rear side of the carrier 14. Light emanating from the lighting system 19 can be guided through the apertures 18 in order to display the symbol 17 on the front side 12 of the decorative layer 11 by backlighting.

According to the embodiment shown in FIG. 2, the symbols 17 are each formed by a partial printed and/or color coating 20 on the front side 12 of the decorative layer 11.

According to the embodiment shown in FIG. 3, the symbols 17 are formed by depressions 21 in the surface of the decorative layer 11, which are formed by embossing.

In addition, mixed forms are also possible, wherein the symbols 17 are formed partly by means of apertures (with or without backlighting) and/or partly by means of color and/or printed layers and/or partly by means of depressions and/or elevations.

The shaped part 10 according to the embodiments shown in FIGS. 1 to 3 comprises a feedback element 22 for each CMUT sensor and/or control element 15 for generating a feedback signal, wherein the feedback elements 22 are connected to the respectively associated CMUT sensor and/or control elements 15 in order to output a feedback signal for the operator upon detection by the CMUT sensor and/or control element 15 of a touch of the front side 12 of the decorative layer 11 by an operator. The feedback elements 22 may be haptic feedback elements, for example vibration devices, for outputting a haptic feedback signal, or visual feedback elements, for example lighting devices, for outputting a visual feedback signal, or acoustic feedback elements, for example loudspeakers, for outputting an acoustic feedback signal.

The shaped part 10 further comprises a control device 23, wherein the control device 23, for example a microcontroller, is connected to the CMUT sensor and/or control elements 15, wherein a control signal for controlling external units is generated by the control device 23 when an operator touches the front side 12 of the decorative layer 11 as detected by the CMUT sensor and/or control elements 15. The control signal can, for example, control electrical and/or electronic units provided in the vehicle interior, such as the backrest and/or armrest adjustment devices, the air conditioning, the ventilation, the lighting, the radio and/or the navigation system, etc.

### LIST OF REFERENCE SIGNS

10 Shaped part
11 Decorative layer
12 front side (decorative layer)
13 Rear side (decorative layer)
14 Carrier
15 CMUT sensor and/or control elements
16 Rear side (carrier)
17 Symbol
18 Apertures
19 Lighting system
20 Printed and/or color coating
21 Depression
22 Feedback element
23 Control device

1. A shaped part comprising a decorative layer having a front side designed as a visible side and a rear side opposite the front side and a carrier arranged on the rear side of the decorative layer,
characterized in that
one or more Capacitive micromachined ultrasonic transducers (CMUT) sensor and/or control elements are arranged on or in the shaped part wherein the CMUT sensor and/or control element(s) are provided for detecting a touch of or an approach towards the front side of the decorative layer by an operator.

2. The shaped part according to claim 1,
characterized in that
the decorative layer comprises a conductive material or is made of a conductive material.

3. The shaped part according to claim 2,
characterized in that
the conductive material is or comprises aluminum and/or carbon and/or stainless steel.

4. The shaped part according to claim 1,
characterized in that
the CMUT sensor and/or control elements are attached to the rear side of the carrier.

5. The shaped part according to claim 4,
characterized in that
the CMUT sensor and/or control element(s) are attached to the rear side of the carrier without an air gap and/or without an intermediate layer.

6. The shaped part according to claim 1,
characterized in that
one or more symbols are provided on the front side of the decorative layer, wherein one CMUT sensor and/or control element is assigned to each symbol and/or is arranged in the region of the symbol on the rear side of the carrier.

7. The shaped part according to claim 6,
characterized in that
the symbol(s) are each formed by one or more apertures in the decorative layer, wherein the aperture(s) extend from the rear side of the decorative layer to the front side of the decorative layer through the decorative layer and wherein a lighting system is arranged on the rear side of the decorative layer, wherein light emanating from the lighting system is or can be guided through the aperture(s) to the front side of the decorative layer in order to display the symbol.

8. The shaped part according to claim 6,
characterized in that
the symbol(s) are formed by a partial printed and/or color coating on the front side of the decorative layer.

9. The shaped part according to claim 6,
characterized in that
the symbol(s) are formed by depressions in the surface of the decorative layer and/or elevations from the surface of the decorative layer.
characterized in that
the shaped part comprises one or more feedback elements for generating a feedback signal, wherein the feedback element(s) are connected to the CMUT sensor and/or control element(s) in order to output a feedback signal for the operator upon detection by the CMUT sensor and/or control element(s) of a touch of or an approach towards the front side of the decorative layer by an operator.

11. The shaped part according to claim 10,
characterized in that
the feedback element(s) are or comprise haptic feedback elements for outputting a haptic feedback signal and/or visual feedback elements for outputting a visual feedback signal and/or acoustic feedback elements for outputting an acoustic feedback signal.

12. The shaped part according to claim 1,
characterized in that
the shaped part has a control device wherein the control device is connected to the CMUT sensor and/or control element(s) a control signal for controlling external units being generated by the control device when an operator touches or approaches the front side of the decorative layer as detected by the CMUT sensor and/or control elements.

13. The shaped part according to claim 1.
characterized in that
the shaped part is a decorative part and/or panel part designed as a shaped part for a vehicle interior.
